(19) United States
(12) Patent Application Publication
(10) Pub. No.: US 2015/0118660 A1
(43) Pub. Date: Apr. 30, 2015

(54) System for and methods of teaching and learning foreign languages online using spreadsheets created by web-based document creating software

(71) Applicant: Vladimir Kovin, Jersey City, NJ (US)

(72) Inventor: Vladimir Kovin, Jersey City, NJ (US)

(21) Appl. No.: 14/062,139

(22) Filed: Oct. 24, 2013

(51) Int. Cl. G09B 5/02; G06F 17/24; G09B 19/06

(52) U.S. Cl. CPC G09B 5/02; G09B 19/06; G06F 17/246
USPC 434/157

(57) ABSTRACT

Novel systems/methods for generating language learning lessons is disclosed in the present application. A learner is allowed to speak out loud a sentence in a foreign language while an instructor types down exactly how the sentence is spoken in a first column on an instruction sheet. The instructor then types a correct sentence marked with symbols noting the incorrect word and missing word in a second column parallel to the first column. Unfamiliar word is then placed in a third column and mispronounced word is placed in a fourth column. The present invention further has other features to allow the learner(s) to see his/her verbal mistakes, become conscious of these mistakes and thereby control his/her way of using those words in the correct way much more efficiently.

### BACKGROUND OF THE INVENTION

1. Field of the Invention

The present invention relates to a system for and a method of teaching and learning foreign languages online using web-based office software to enable instructor(s) to teach learner(s) by creating, editing and sharing teaching/learning materials in real-time using Internet browsers. More particularly, the present invention relates to a system for and a method of one-on-one teaching and learning foreign languages online using spreadsheets of web-based office software that allows the instructor(s) and learner(s) to create, edit and exchange a series of custom made teaching/learning materials in real time.

2. Description of Related Art

Note that the points discussed below may reflect the hindsight gained from the disclosed inventions, and are not necessarily admitted to be prior art.

In addition to mastering a native language mastering a foreign language is more difficult for many people. Numerous educational methods and systems have been developed to facilitate people to learn foreign languages.

More specifically, by way of example, U.S. PreGrant Publication No. 2010/0159425 (A1) is one of a multimedia systems where a DVD authoring tool arranges a first stream of video clips together with a synchronize audio in a foreign language. A symbolic marker is placed in a subtitle track associated with the first stream. The marker symbolizes upcoming complex word usage, grammar patterns, idiomatic expressions, and colloquialisms in the first stream, and is linked to a second stream of video clips, the second stream of video clips including synchronized audio of an instructional nature regarding the target language of the first stream of video clips. During DVD play, user selects a symbolic marker to pause the first stream and plays the second stream, the first stream resuming upon completion of the second stream.

U.S. PreGrant Publication No. 2010/0159425 (A1) discloses another type of language learning tool which uses a weighting factor for the learning system that scores a learner's correct answers to an audio data. The weighting factor is updated according to an acoustic model and a language model.

U.S. PreGrant Publication No. 2010/0076943 (A1) discloses another computer aided language learning tool which uses database of language sentences in comparison with corresponding foreign language sentences. Language structures of individual sentences are analyzed in parallel.

It is recognized that there are numerous methods and styles of teaching languages. However, none of these methods provide a very satisfactory solution for the very personal nature of language learning. The pre-programmed teachings inherently cannot satisfy all the needs of a learner.

### SUMMARY OF THE INVENTION

In an exemplary embodiment of the present invention, there is disclosed a system for and method of teaching/learning foreign languages online in real time using web-based office software that allows instructor(s) and learner(s) to interact over the Internet in real time. The system and method is used to teach learner foreign language by creating, editing and sharing teaching/learning materials in real time so that the teaching/learning materials can be custom made based on each individual learner's ability and satisfy the very personal nature of language learning.

The web-based office software such as Google™ Docs. allows users to create and edit documents online while collaborating in real-time with other users.

The present invention further has features to analyze the lessons and thus allows the learner(s) to see his/her verbal mistakes, become conscious of these mistakes and thereby control his/her way of using those words in the correct way much more efficiently.

The present application discloses new approaches for generating personalized language learning lessons.

In one embodiment, at least one spreadsheet is created using the web-based office software for the instructor(s) and learner(s) to type in for each lesson and to share in real-time over the Internet between the instructor(s) and learner(s) for each lesson. The spreadsheet is used as an instruction sheet described hereinafter.

In one embodiment, an instruction sheet is used, for lesson one, an instructor types down everything that a language learner says in a first column. After a thought of the learner is finished, the instructor corrects what in the first column using different symbols for incorrect words and phrases and for missing words in a second column. The new words or phrases from the first and second columns are put in a third column.

These new words and phrases are subsequently copied to a new instruction sheet for the second lesson, and the learner uses the new words to write sentences in a first column, and the instructor corrects the sentences in a second column during lesson 2. The learner also reads out loud the mispronounced words. If the word was not pronounced correctly, the word continues to be transferred to the next lesson.

In one embodiment, the learner reads material based on his/her interests, and as he/she reads, the instructor types the mispronounced words in a fourth column. Instructor then adds all the unfamiliar words (new words/new phrases) in a third column.

In one embodiment, the instruction sheet is generated from Google™ Doc. and spreadsheet program that can be shared and saved by learners and instructors remotely via the Internet. The language lessons are generated remotely.

This interactive process of generating language lessons allows the learner(s) to interact with the instructor(s) in real-time so as to generate personalized language learning lessons. The present invention further has other features to allow the learner(s) to see his/her verbal mistakes, become conscious of these mistakes and thereby control his/her way of using those words in the correct way much more efficiently. Each lesson may be placed on one individual sheet. Communications between the learner and the instructor may be through a phone line, a chat program, or an IP talk program.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

The disclosed invention will be described with reference to the accompanying drawings, which show important sample embodiments of the invention and which are incorporated in the specification hereof by reference, wherein:

FIG. 1 schematically shows an example instruction sheet in accordance with this application.

FIG. 2 shows a screenshot of an example personalized lesson generated using Google™ Docs. interface for the first lesson.

FIG. 3 shows a screenshot of an example personalized lesson generated using Google™ Docs. interface for the second lesson.

FIG. 4 shows a screenshot of an example personalized lesson generated using Google™ Docs. Interface for one of the fourth day.

FIG. 5 shows a screenshot of an example cheat sheet as reference for learners to refer to grammar rules about irregular verbs.

FIG. 6 shows a screenshot of an example cheat sheet as reference for learners to refer to grammar rules.

FIG. 7 is a screenshot of an example spreadsheet that displays the difference between the two columns mentioned above is expressed by a percentage.

FIG. 8 is a screenshot of an example spreadsheet that displays the total number of times that new words were used in subsequent classes during the conversation segment of a lesson.

FIG. 9 shows a pie graph of every ten lessons that shows the categorized breakdown of a learner's mistakes.

### DESCRIPTION OF THE PREFERRED EMBODIMENT

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the described systems/methods also applies to other language learning; for clarity reason, the examples are given based on learning English by a Russian speaking learner, but an ordinary person in the art would know the variations to modify lessons to apply to other languages.

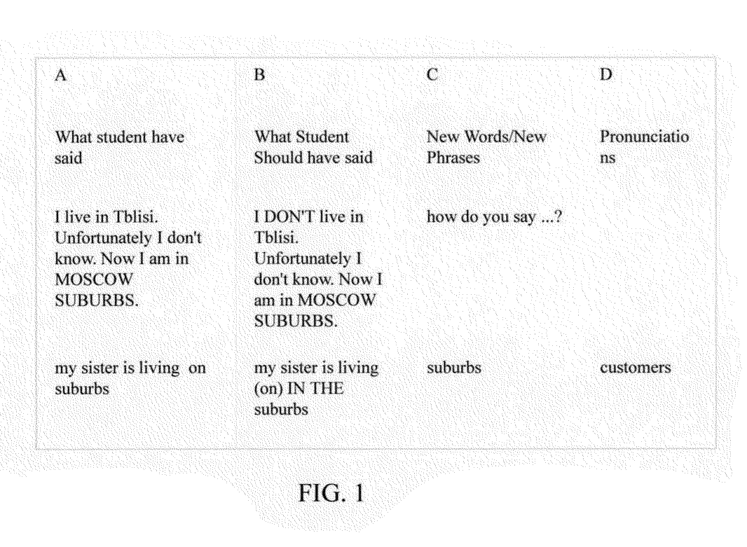

In reference to FIG. 1, it shows a four column instruction sheet for generating language lessons. Column A is for typing in what a learner said, Column B is for the instructor to type in the corrections with emphasis by using features such as color, capital letters or symbols such as parenthesis. Parenthesis may be used to remove the incorrect words or phrases, capital letters to insert what is missing, etc. Column C is used to pick out the new words, and Column D is used to record the mispronounced words. Each row for one thought of the learner.

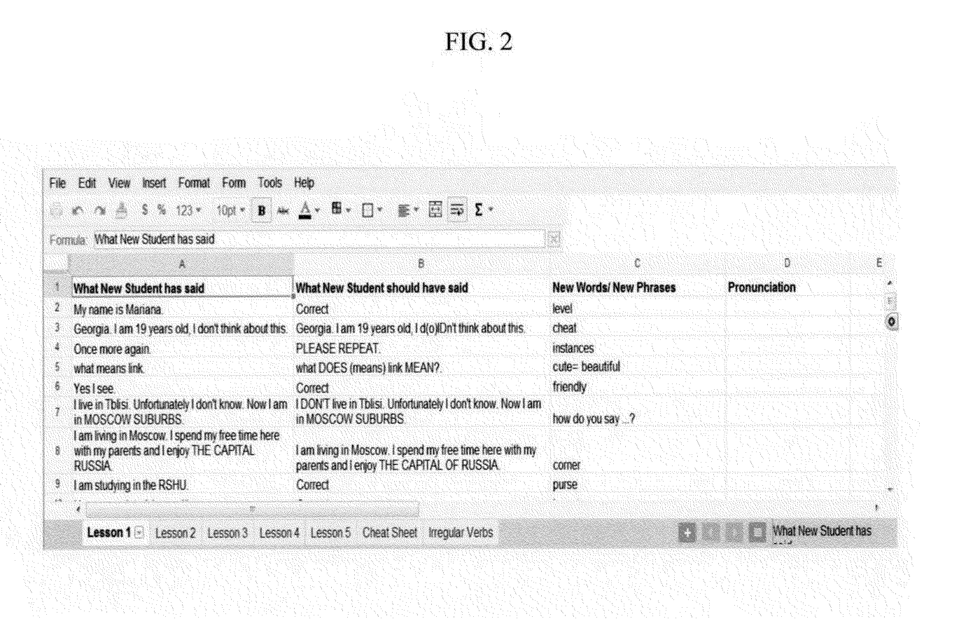

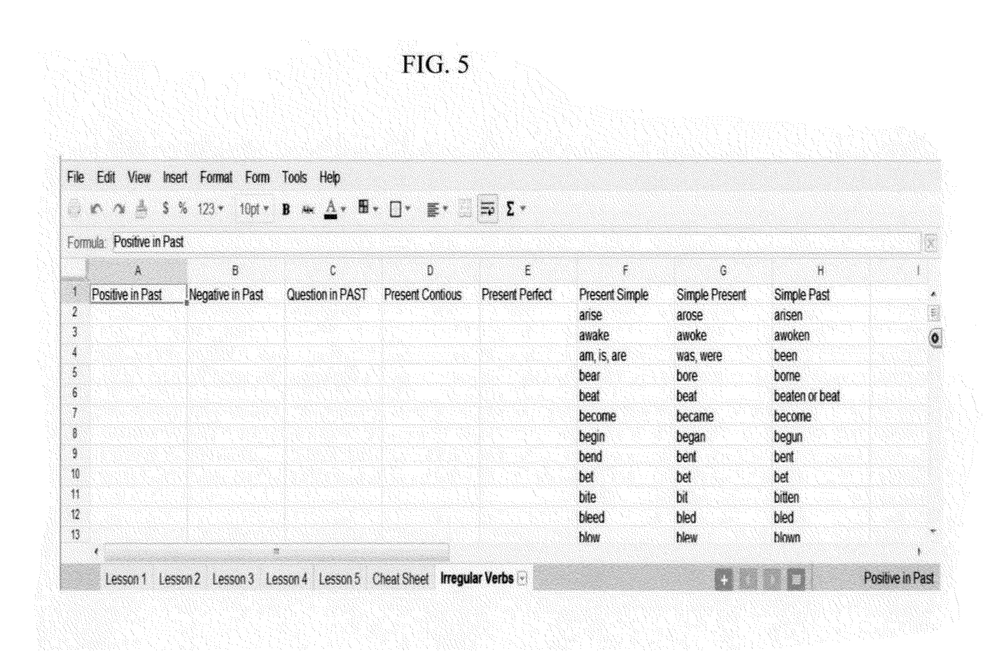

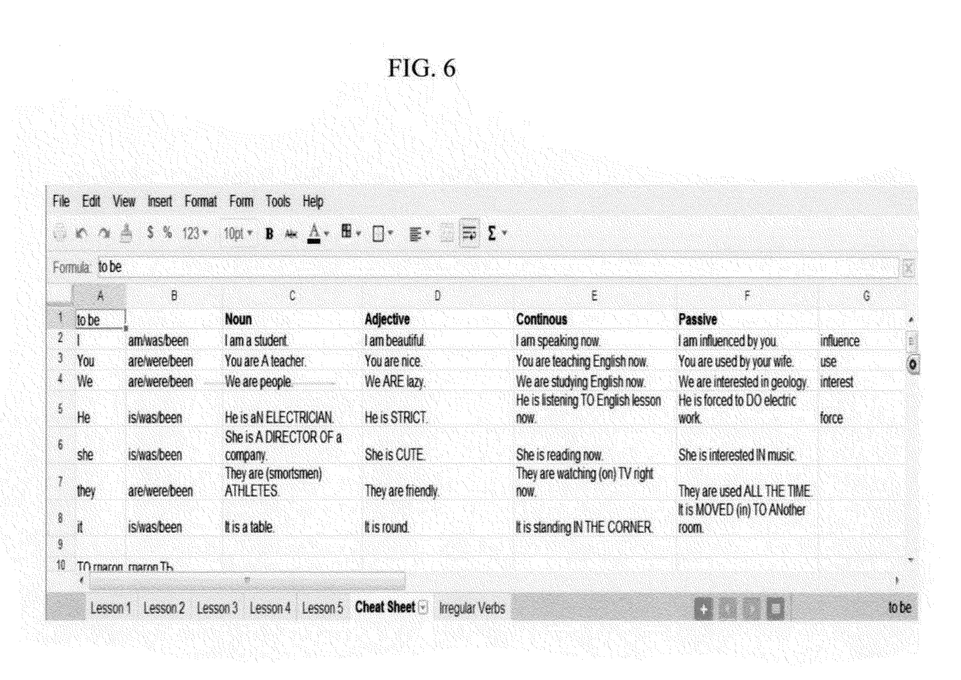

To generate a personalized English lesson, an instructor may first explain a cheat sheet of the irregular verbs and grammar changes in English, as shown in FIGS. 5 and 6, and direct the learner to speak only English in the conversation. Then the learner is directed to speak his/her thoughts, such as to introduce himself/herself, to talk about her/his experience etc. Referring to FIG. 2, there is disclosed an instruction sheet for the first lesson according to one embodiment of the present invention. As the learner speaks, the instructor types down what the learner said in Column A. After the learner finishes one thought, the instructor corrects what is in Column A, and places the correct sentence in Column B, using for example parenthesis to remove the incorrect words/phrases, and capital letters to insert what is missing. The learner then further identifies the unfamiliar words as new words/new phrases and places them in Column C. The learner may be directed to read out loud the correct sentence in Column B, and the instructor records down the mispronounced words in Column D. After the conversation, a first English lesson is generated. The learner is required to make sentences using new words in Column C as homework, and writes them out in Column A on a second, new instruction sheet.

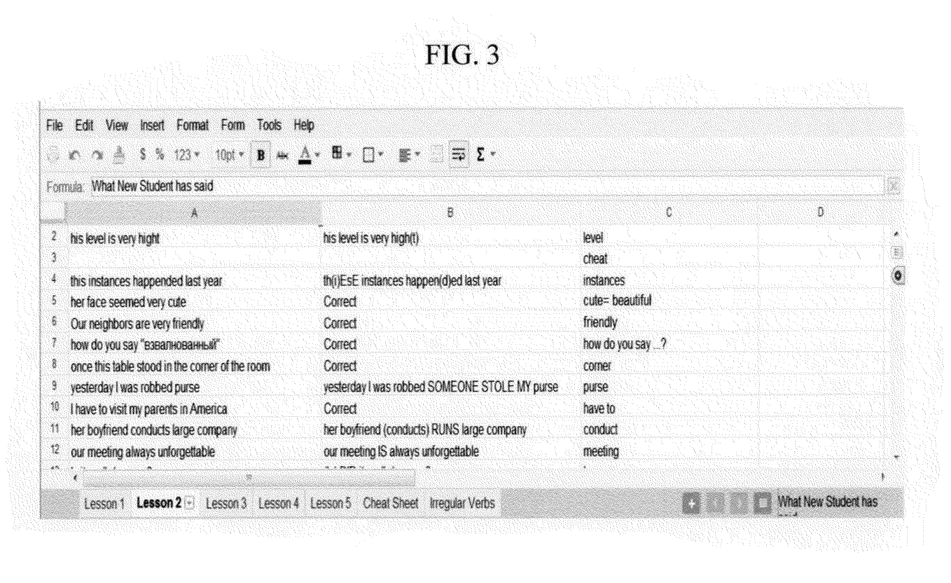

Referring to FIG. 3, there is disclosed an instruction sheet for the next lesson according to one embodiment of the present invention. In the next lesson, the instructor corrects the homework the same way as in the first lesson, and writes the corrected sentences into Column B of the second sheet. The instructor also asks the learner to read out loud the sentences and writes out the mispronounced words in Column D. If the word was not pronounced correctly, the word continues to be transferred to the next lesson until it is pronounced correctly. If the missing words are new words, the new words are placed into Column C. If the new words exceed 50-60 words, the learner and the instructor do the homework together.

In addition, in generating a learning lessons, learner may read material based on his/her interests; then as he/she is reading, the instructor is typing the mispronounced words in Column D. The instructor asks and later places the unfamiliar words in Column C. The instructor can explain and type the meaning of the words in Column C.

In reference to FIGS. 2-4, the lessons can be generated remotely using the internet and an interface such as the Google™ docs, the spreadsheet program, where the spreadsheet can be shared and viewed simultaneously by the learner and the instructor. Each lesson may be placed on one individual sheet. Communications between the learner and the instructor may be through a phone line, a chat program, or an IP talk program.

In FIG. 2, lesson 1 produces new words in Column C. The new words in Column C are used to create new sentences by the learner in Column A of lesson 2 as shown in FIG. 3 as homework. The new sentences are corrected in Column B of lesson 2 during lesson 2, and new unfamiliar words are placed in Column C of lesson 3.

Sometimes the capital letters are found in Column A if the learner did not know how to say the word and asked to say it “how do you say . . . ” by using a native language, such as a Russian word.

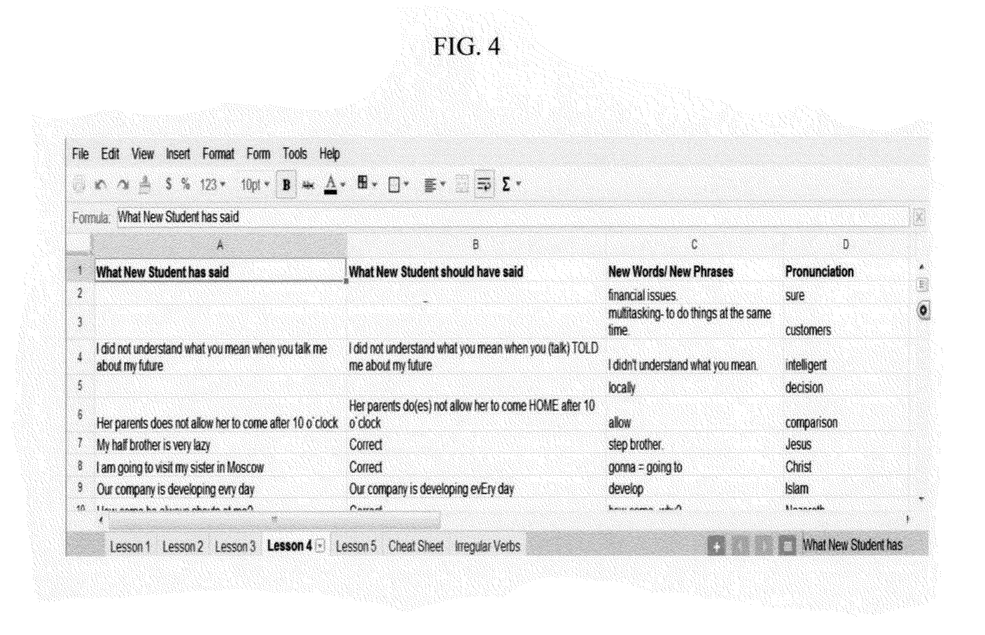

FIG. 4 shows the lesson 4 which can generate a complete set of different new words in Column C than in lesson 1. The instructor puts the mispronounced words in Column D which are continued to be transferred to next lesson until they are pronounced correctly.

Lessons generated may be saved for later review, by both the instructor and the learner, to solidify or test what the learner has learned.

In addition, the present invention has features to analyze the learner's foreign language learning progress. The present invention includes features that demonstrate the process described in the previous application in order to show the learners' results.

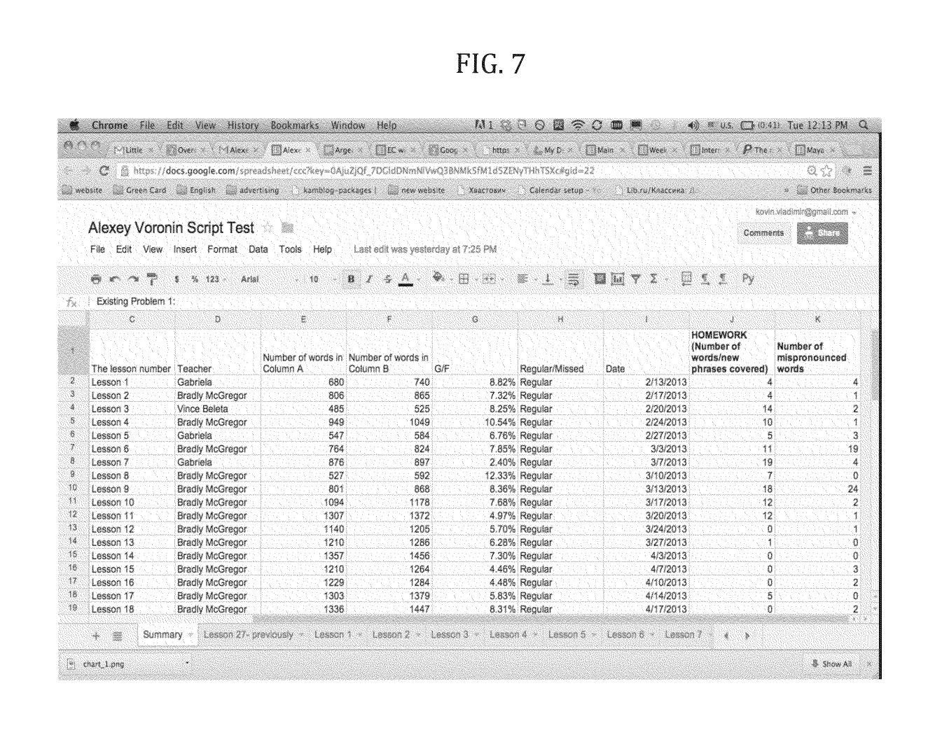

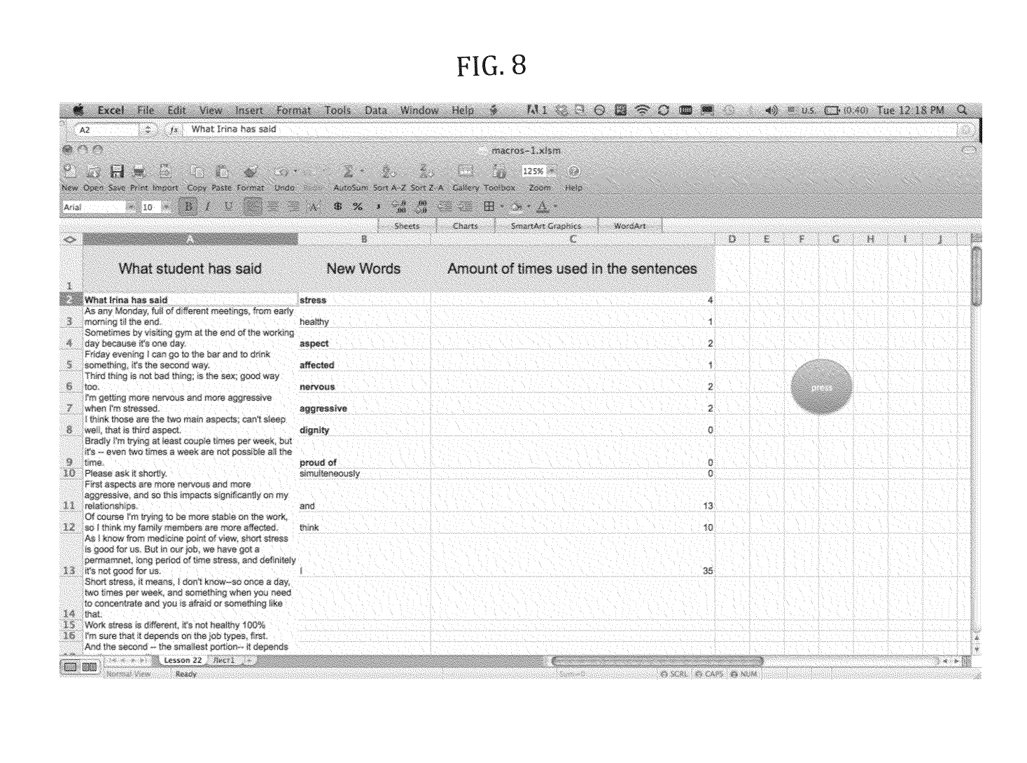

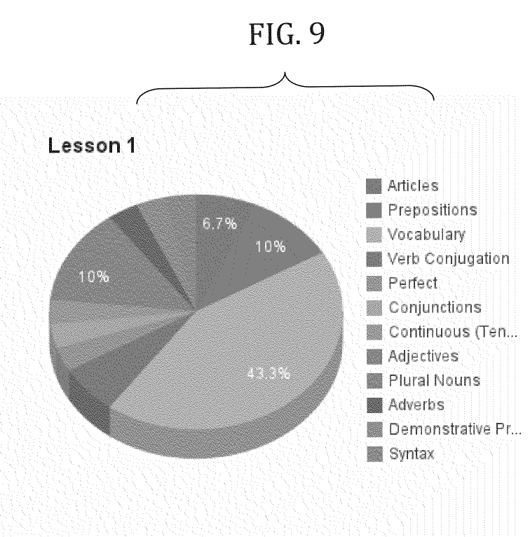

In one embodiment, by utilizing various built-in devised formulas and macros in Microsoft Excel, the system calculates and displays the following (all the numbers are limited by the duration which is normally 90 minutes long):
A spreadsheet that shows the total number of words and/or characters said by a learner and typed by an instructor during a lesson. These words may be found in column A of each lesson in every learner's spreadsheet. (FIG. 7).
A spreadsheet that shows the total number of words and/or characters said by a learner and typed by a instructor, plus the corrections as described in the previous application. These words and/or characters may be found in column B of each lesson in every learner's spreadsheet. (FIG. 7).
The difference between the two columns mentioned above is expressed by a percentage. This percentage represents the mistakes made during a lesson. (FIG. 7).
Column J shows the number of new words learned during a lesson. In order to build their vocabulary, learners use these words to form new sentences within the lessons. (FIG. 7).
Column K shows the number of words mispronounced during each lesson. (FIG. 7).
Column C shows the total number of times that new words were used in subsequent classes during the conversation segment of a lesson. (FIG. 8).
We provide a pie graph every ten lessons that shows the categorized breakdown of a learner's mistakes. (FIG. 9).

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for teaching foreign language online using an Internet interactive process to enable custom made teaching/learning materials and allow learners to see their own mistakes thus improving their language ability more efficiently, the system comprising:
a web-based office software which enables an instructor and a learner to interact in real time via an Internet;
a computer and/or phone equipped with a speaker for the learner;
a computer and/or phone equipped with a speaker for the instructor; and
at least one instruction sheet is created using spreadsheet of the web-based office software for the instructor and learner to type in for each lesson and share real-time over the Internet between the instructor and learner for each lesson;
wherein the instructor types foreign language sentences that are spoken by the learner in a first column of the instruction sheet and types correct sentences corresponding to the learner's spoken sentences using a plurality of symbols marking out a correction in a second column of the instruction sheet in parallel to the first column and types unfamiliar words that are identified by the learner in a third column of the instruction sheet and types mispronounced words into a fourth column of the instruction sheet.

2. The system of claim 1, wherein the instructor and the learner carry verbal communications through a phone line, a chat program, or an IP talk program.

3. The system of claim 1, wherein the system transfers the mispronounced word to a next lesson until it is correctly pronounced.

4. The system of claim 1, wherein the said plurality of symbols includes parenthesis for incorrect word, and capital letters for missing word.

5. The system of claim 1, wherein the instruction sheet shows the number of words mispronounced during each lesson.

6. The system of claim 1, wherein the instruction sheet shows the number of new words learned during a lesson.

7. The system of claim 1, wherein the instruction sheet utilizing various built-in devised formulas and macros to calculate and display the total number of words and/or characters typed in the first column and second column, respectively.

8. The system of claim 1, wherein the instruction sheet utilizing various built-in devised formulas and macros to calculate and display the difference between the first and second columns and express the difference in a percentage.

9. The system of claim 1, wherein the instruction sheet utilizing various built-in devised formulas and macros to calculate and display a pie graph every ten lessons that shows the categorized breakdown of a learner's mistakes.

10. The system of claim 1, further comprising a central server for providing the instruction sheets having built-in devised formulas and macros to calculate, perform analysis and display the analysis results to allow the learners to see his/her verbal mistakes, become conscious of these mistakes and thereby control his/her way of using those words in the correct way much more efficiently.

11. A method for teaching a foreign language using an Internet interactive process to enable custom made teaching/learning materials and allow learners to see their own mistakes thus improving their language ability more efficiently, the system comprising the steps of:
creating at least one instruction sheet for each lesson using a web-based office software over the network such that the instruction sheet is shared in real-time over the Internet between a learner and an instructor;
instructing said learner to speak out loud a spoken sentence in the foreign language;
typing down a written sentence corresponding to the spoken sentence in the foreign language in a first column on a first instruction sheet;
typing a correct sentence corresponding to the written sentence using plurality of symbols marking out a correction in a second column in parallel to the first column on the first instruction sheet;
instructing the learner to identify unfamiliar words from the correct sentence and writing the unfamiliar words in a third column on the first instruction sheet; and
placing mispronounced words in a fourth column on the first instruction sheet.

12. The method of claim 11, further comprising the steps of:
copying said unfamiliar words in the third column of the first instruction sheet to a first column of a second instruction sheet;
copying mispronounced words in the fourth column of the first instruction sheet to a fourth column of the second spreadsheet; and
instructing the learner to use the unfamiliar words in the first column of the second spreadsheet to make sentences as a homework.

13. The method of claim 11, wherein the web-based office software is Google™ Docs. on a central server in a network.

14. The method of claim 11, further comprising the step of transferring the mispronounced word to next lesson until it is correctly pronounced.

15. The method of claim 11, wherein said plurality of symbols includes parenthesis for incorrect word, and capital letters for missing word.

16. The method of claim 11, wherein the learner is allowed to speak out a word in its native language by asking the instructor for the corresponding word in the foreign language.

17. The method of claim 11, wherein the instruction sheet shows the total number of times that new words were used in subsequent lessons during the conversation segment of a lesson.

18. The method of claim 11, wherein the instructor and the learner carry verbal communications through a phone line, a chat program, or an IP talk program.

19. The method of claim 11, wherein the instruction sheet utilizing various built-in devised formulas and macros to calculate and display the total number of words and/or characters typed in the first column and second column, respectively and the difference between the first and second columns and express the difference in a percentage.

20. The method of claim 11, wherein the spreadsheet utilizing various built-in devised formulas and macros to calculate and display a pie graph every ten lessons that shows the categorized breakdown of a learner's mistakes.
